(19) United States
(12) Patent Application Publication
(10) Pub. No.: US 2019/0284873 A1
(43) Pub. Date: Sep. 19, 2019

(54) INTEGRATED SYSTEM AND A METHOD FOR INSTALLING AN INTEGRATED SYSTEM

(71) Applicant: Dagan Benzur, Sade Eliezer, IL (US)

(72) Inventor: Dagan Benzur, Sade Eliezer, IL (US)

(21) Appl. No.: 15/924,436

(22) Filed: Mar. 19, 2018

Related U.S. Application Data
(60) Provisional application No. 62/618,714, filed on Feb. 15, 2018.

(51) Int. Cl. E06B 9/42

(52) U.S. Cl. CPC E06B 9/42

(57) ABSTRACT

An integrated system that may include a motorized rollable shutter system and a window frame; wherein the motorized rollable shutter system comprises a housing, a rollable shutter, a rolling element, and motor for rotating the rolling element, wherein a rotation of the rolling element assists to in a winding and an unwinding of the rollable shutter; wherein window frame the is either connected to the housing or is integrated with the housing; wherein the window frame comprises at least one rollable shutter guiding element for guiding the a rollable shutter during a rolling and unrolling of the rollable shutter; and wherein the window frame comprises at least one window guiding element for guiding at least one window when the at least one window moves in relation to the window frame.

### CROSS REFERENCE

This application claims priority from US provisional patent 62/618,714 filing date Jan. 18, 2018.

### BACKGROUND

The installation of a set of windows and an installation of a motorized rollable shutter system is complex and costly. Different parts of the installation are executed by different professionals.

There is a growing need to simplify the installation process and to reduce the cost of the installation process.

### SUMMARY

There may be provided an integrated system that may include a motorized rollable shutter system and a window frame; wherein the motorized rollable shutter system may include a housing, a rollable shutter, a rolling element, and motor for rotating the rolling element, wherein a rotation of the rolling element assists to in a winding and an unwinding of the rollable shutter; wherein the window frame may be either connected to the housing or may be integrated with the housing; wherein the window frame may include at least one rollable shutter guiding element for guiding the a rollable shutter during a rolling and unrolling of the rollable shutter; and wherein the window frame may include at least one window guiding element for guiding at least one window when the at least one window moves in relation to the window frame.

The at least one rollable shutter guiding element may be parallel to one or more of the at least one window guiding element.

The at least one rollable shutter guiding element may include at least one recess formed in the window frame and wherein the at least one window guiding element may include at least one rail.

The at least one rollable shutter guiding element may be formed in an exterior portion of the window frame, wherein the at least one window guiding element may belong to an inner portion of the window frame.

The inner portion of the window frame may be shaped and sized to fit in a portion of a wall opening that may be formed within a wall; and wherein the exterior portion of the window frame may be shaped and sized to extend outside the wall opening.

The window frame further may include an adjustable internal interface that may be configured to interface with an interior surface of the wall.

The window frame further may include a non-adjustable internal interface that may be configured to interface within an interior surface of the wall.

The at least one rollable shutter guiding element may include a pair of recesses that may be positioned at opposite sides of the window frame; wherein the at least one window guiding element may include a pair of rails that may be positioned at the opposite sides of the window frame; wherein a distance between the pair of recesses differs from a distance between the pair of rails.

The at least one rollable shutter guiding element may be formed in a front portion of the window frame, wherein the at least one window guiding element belongs to an interior portion of the window frame; wherein the front portion of the window frame may be shaped and sized to fit in a portion of a wall opening of a wall; and wherein the interior portion of the window frame may be shaped and sized to extend outside the wall opening and to interface with an interior surface of the wall.

The window frame further may include an adjustable internal interface that may be configured to interface within an exterior portion of the wall.

The at least one rollable shutter guiding element may include a pair of recesses that may be positioned at opposite sides of the window frame; wherein the at least one window guiding element may include a pair of rails that may be positioned at the opposite sides of the window frame; wherein a distance between the pair of recesses differs from a distance between the pair of rails.

The integrated system may include the at least one window.

The rolling element may be adapted to have the rollable shutter wrapped around.

The integrated system may include an additional rolling element that may be spaced apart from the rolling element, and wherein the rollable shutter may be configured to be wrapped around the rolling element and the additional rolling element.

The motorized rollable shutter system may be positioned above the window frame.

The integrated system may include at least one screen interface that may be connected to a screen.

The integrated system may include at least movable screen that may be configured to move along at least one screen interface of the integrated system.

The at least one window guiding element may be configured to guide the at least one window when the at least one window performs a rotational movement in relation to the window frame.

The at least one window guiding element may be configured to guide the at least one window when the at least one window performs a vertical movement in relation to the window frame.

The at least one window guiding element may be configured to guide the at least one window when the at least one window performs a horizontal movement in relation to the window frame.

There may be provided a method for installing an integrated system, the system may include installing the integrated system within a wall opening of a wall; wherein the integrated system may include a motorized rollable shutter system and a window frame; wherein the motorized rollable shutter system may include a housing, a rollable shutter, a rolling element, and motor for rotating the rolling element, wherein a rotation of the rolling element assists to in a winding and an unwinding of the rollable shutter; wherein window frame the may be either connected to the housing or may be integrated with the housing; wherein the window frame may include at least one rollable shutter guiding element for guiding the a rollable shutter during a rolling and unrolling of the rollable shutter; and wherein the window frame may include at least one window guiding element for guiding at least one window when the at least one window moves in relation to the window frame.

The method may include installing any of the integrated systems illustrated in the current patent application.

Any combination of any components of any of the figures may be provided.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an example of a wall having a wall opening and of parts of an integrated system;

FIG. 2 is an example of a wall having a wall opening and of parts of an integrated system;

FIG. 3 is an example of parts of the integrated system;

FIG. 4 is an example of parts of the integrated system;

FIG. 5 is an example of a wall having a wall opening and of parts of an integrated system;

FIG. 6 is an example of a wall having a wall opening and of parts of an integrated system;

FIG. 7 is an example of parts of the integrated system;

FIG. 8 is an example of a part of the wall and of parts of the integrated system;

FIG. 9 is an example of a part of the wall and of parts of the integrated system;

FIG. 10 is an example of a part of the wall and of parts of the integrated system;

FIG. 11 is an example of a part of the wall and of parts of the integrated system;

FIG. 12 is an example of a part of the wall and of parts of the integrated system; and

FIG. 13 is an example of a part of the wall and of parts of the integrated system.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using mechanical components known to those skilled in the art, details will not be explained in any greater extent than that considered necessary as illustrated above, for the understanding and appreciation of the underlying concepts of the present invention and in order not to obfuscate or distract from the teachings of the present invention.

The term “comprising” is synonymous with (means the same thing as) “including,” “containing” or “having” and is inclusive or open-ended and does not exclude additional, unrecited elements or method steps.

The term “consisting” is a closed (only includes exactly what is stated) and excludes any additional, unrecited elements or method steps.

The term “consisting essentially of” limits the scope to specified materials or steps and those that do not materially affect the basic and novel characteristics.

In the claims and specification any reference to the term “comprising” (or “including” or “containing”) should be applied mutatis mutandis to the term “consisting” and should be applied mutatis mutandis to the phrase “consisting essentially of”.

There is provided an integrated system that is easy to install and can be manufactured in mass production—which lowers both the installation cost of the integrated system and the manufacturing cost of the integrated system.

The installation process may consists essentially of placing a portion of the integrated system into a wall opening and connecting a frame of the integrated system to the wall. The integrated system may include adjustable or non-adjustable adaptors for interfacing with an interior and/or an exterior of the wall.

The integrated system may be manufactured in few standard dimensions to fit wall openings of few standard dimensions. This will simplify the manufacturing of the integrated system and may ease the installation process—as the integrated circuit is shaped and sized to fit a wall opening—and there is no need to use further adaptors.

The integrated system may include a motorized rollable shutter system and a window frame.

The motorized rollable shutter system may include a housing, a rollable shutter, a rolling element, and motor for rotating the rolling element.

A rotation of the rolling element assists to in a winding and an unwinding of the rollable shutter. For example, the rotation of the rolling element may be adapted to have the rollable shutter wrapped around. Yet for another example, the rollable shutter may wrapper around the rolling element and another rolling element. The other rolling element may be parallel to the rolling element. This arrangement may reduce the width of the motorized rollable shutter system—which may be beneficial when the wall is thin.

The integrated system is integrated in the sense that it includes different systems or subsystems (motorized rollable shutter system and window subsystem) that are connected to each other or integrated with each other.

The window frame is either connected to the housing or is integrated with the housing.

The window frame may include at least one rollable shutter guiding element for guiding the rollable shutter during a rolling and during an unrolling of the rollable shutter.

The window frame may include least one window guiding element for guiding at least one window when the at least one window moves in relation to the window frame.

In different configurations of the integrated system the at least one window may move in different manners in relation to the window frame—(a) upwards or downwards, (b) sideways, (c) in a rotation manner.

The integrated system may also include one or more static window interface that is adapted to be connected to a window that does not move in relation to the window frame.

The window frame may also include one or more screen interfaces that is configured to interface with a screen. The screen may be static or may be movable in relation to the window frame. If the screen is movable, then the one or more screen interfaces may be screen guiding elements such as rails and/or recesses.

The wall may include a wall exterior plane, and wall interior plane and the wall opening. A part of the integrated system may be adapted to be positioned within the wall opening while one or more parts of the integrated system may extend outside the wall opening—and extend outside the wall exterior plane and/or outside the interior plane.

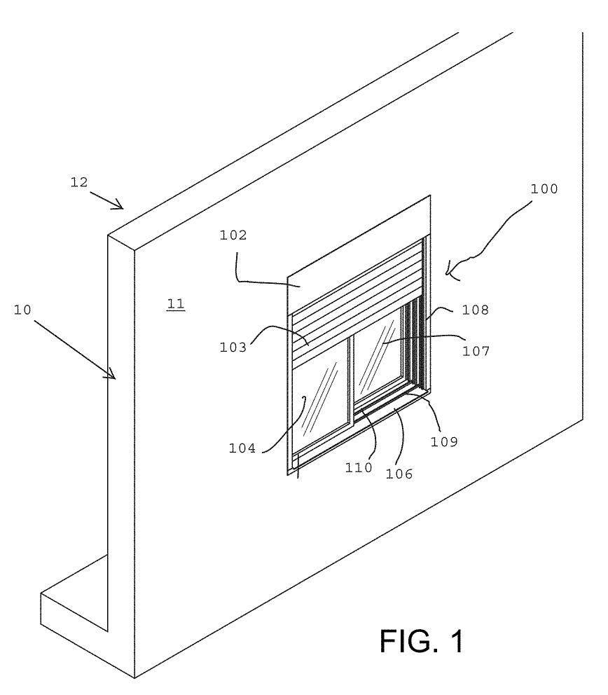

FIG. 1 illustrates an example of a wall 10 that has an interior plane 12 and an exterior plane 11. The interior plane is hidden. The integrated system 100 is installed in a window opening. FIG. 1 illustrates the front panel 102 of a housing of a motorized rollable shutter system, the rollable shutter 103, a screen 104, a window 107, a side rim 108 of a window frame, a bottom rom 106 of the window frame, a screen guiding element, and a window guiding element 110.

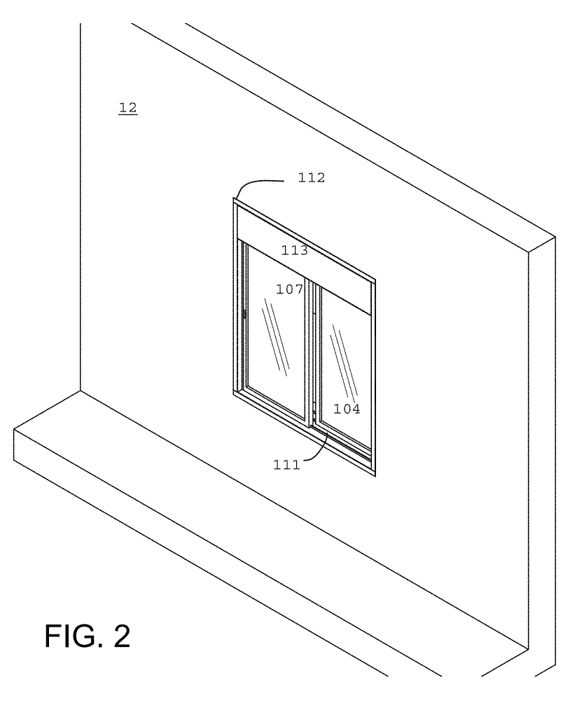

FIG. 2 illustrates an example of the interior surface 12 of wall 10, an interior panel 113 of the housing, screen 104, window 107 and internal interfaces (such as ribs) 112 that are mechanically coupled to the window frame (they may or may not be adjustable) and are eventually connected to the interior panel during the installation of the integrated circuit.

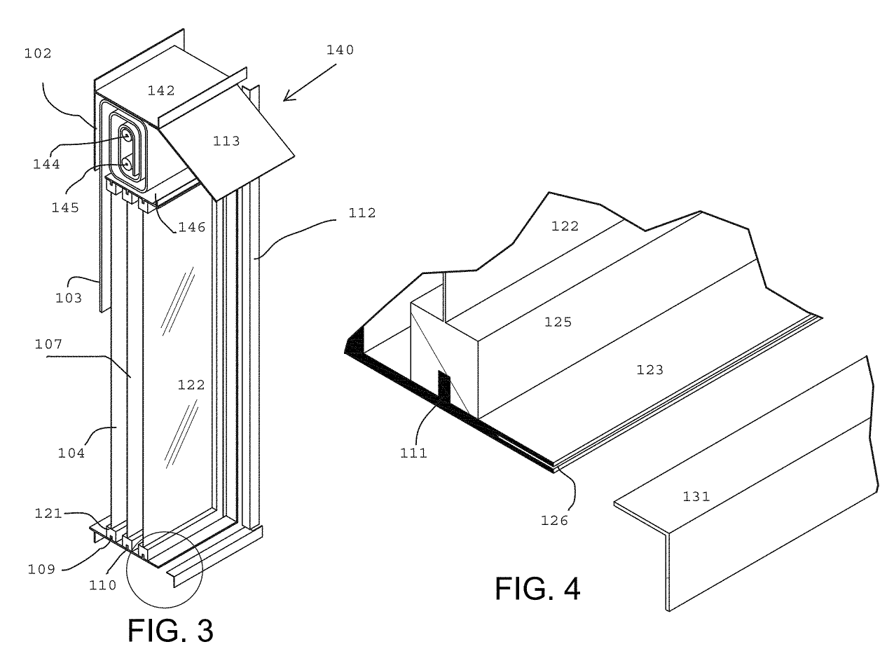

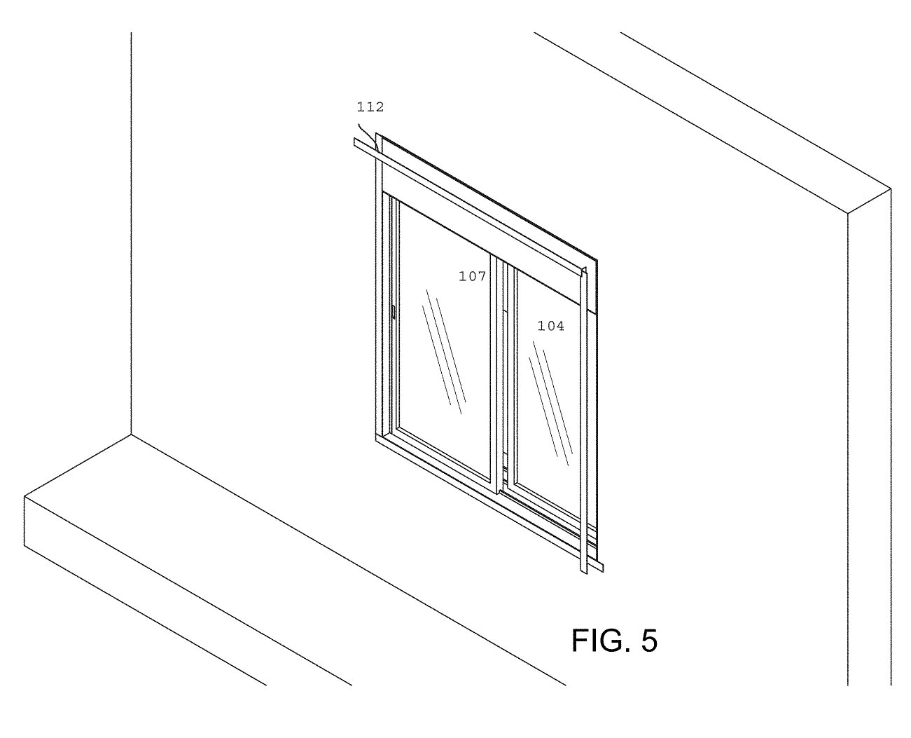

FIG. 3 and FIG. 4 illustrate rollable shutter 103, screen 104, window 107, window 122, screen frame 121, screed guiding element 109, window guiding element 110, internal interfaces 131 and 112, base rim 126 of window frame, window frame 125, rollable element 144, another rollable element 145, bottom panel 146 of housing.

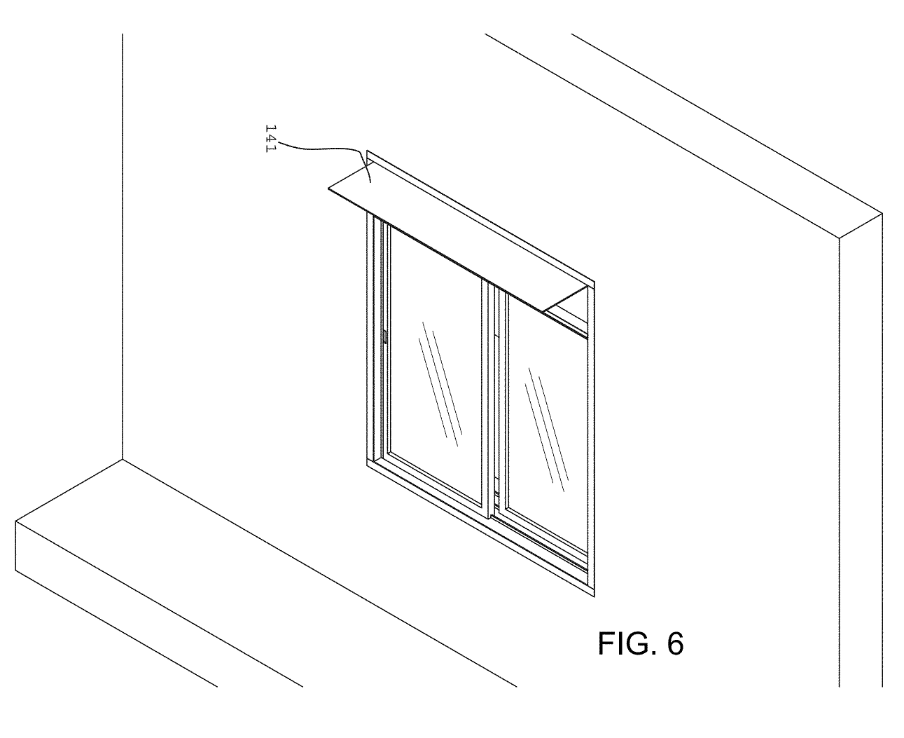

FIG. 5 illustrates screen 104, window 107, and multiple interior elements (such as ribs) 112.

FIG. 6 illustrates screen 104, window 107, and multiple interior elements (such as ribs) 112.

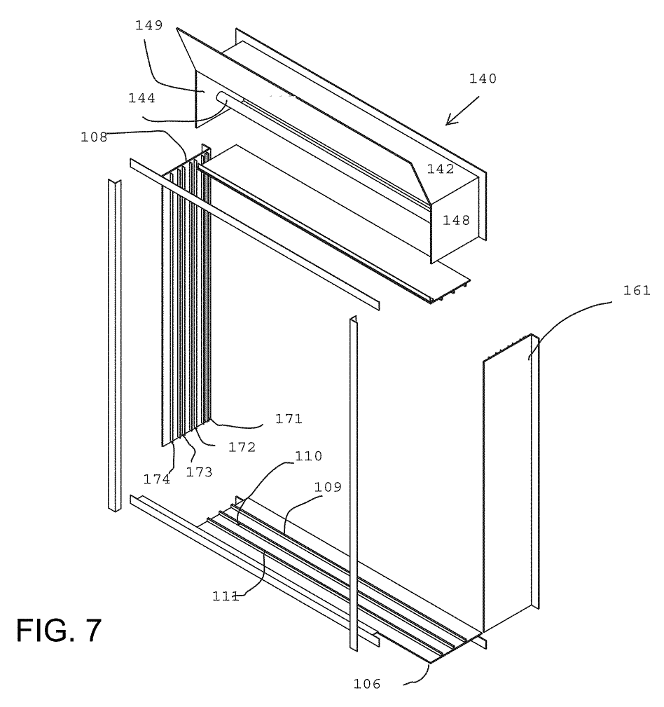

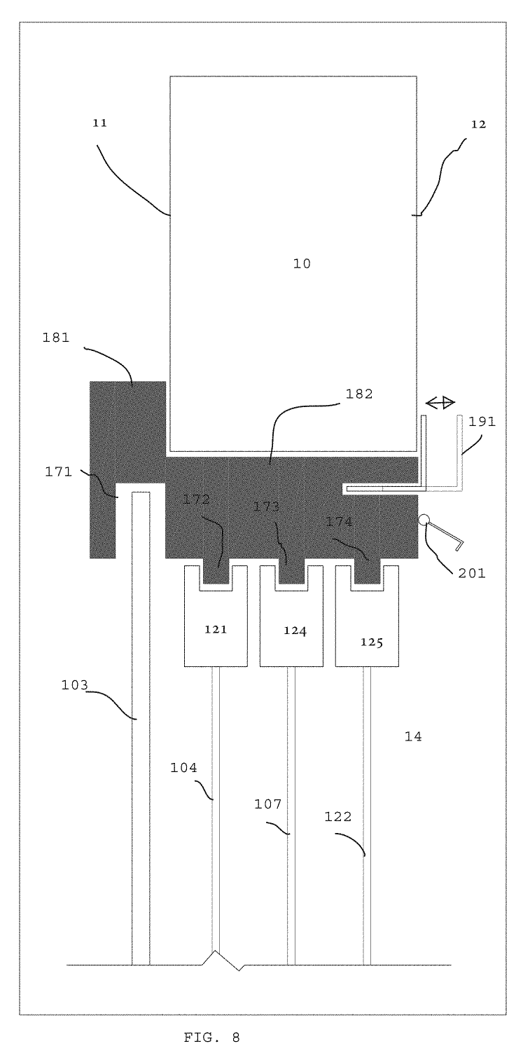

FIG. 7 is an exploded view of window frame and of the motorized rollable shutter system 140. FIG. 7 shows side panels 148 and 149 of the housing, interior panel of the housing, bottom panel of the housing, rollable element 144, bottom rim 106 of the window frame, side rims 161 and 108 of the window frame, rollable shutter guiding element 171, window guiding elements 173, 174, 110 and 111, screen guiding elements 172 and 109.

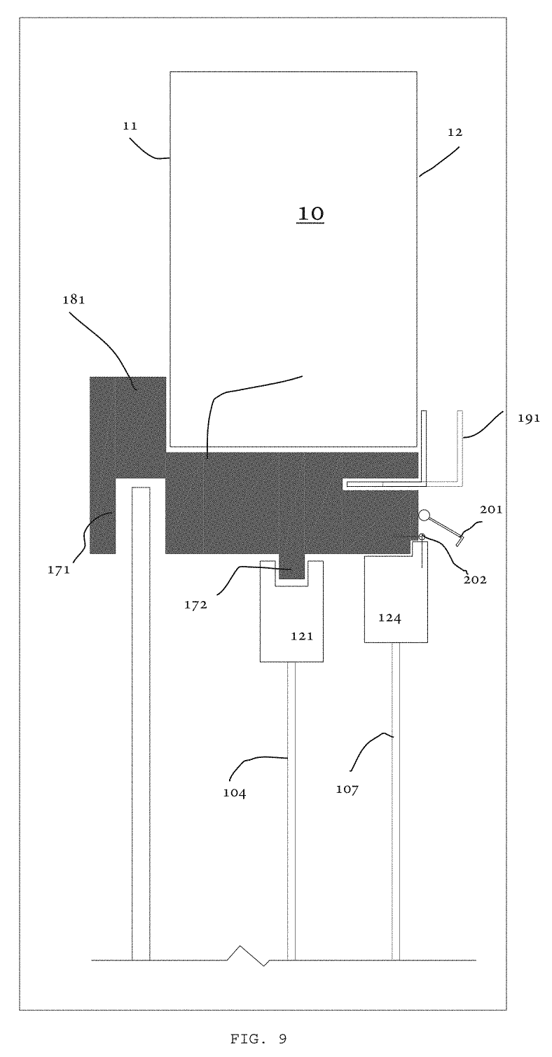

Each one of FIG. 8-11 is an example of a cross sectional view that is taken along a horizontal plane that crosses the side rims of the window frame.

FIG. 8 illustrates wall 10 having interior 12 and exterior 11 surfaces. The window frame has an exterior portion 181 and an inner portion 182.

The exterior portion 181 of the window frame extends outside the wall opening 14 and includes a rollable shutter guiding element 171.

The inner portion 182 of the window frame is positioned within the wall opening 14.

The window frame includes or is coupled to an internal portion 191 (FIG. 8 illustrates an adjustable internal portion 191 that has a L-shaped cross section). FIG. 8 illustrates the two extremum positions of the internal portion—that enable to connect the window frame to walls of different thickness.

The inner portion 182 includes screen guiding element 172, window guiding elements 173 and 174, electrical switch 201.

FIG. 8 also illustrates screen 104, screen frame 121, windows 107 and 122 and window frames 124 and 125.

Screen frame 121 may be static or may be configured to move along screen guiding element 172.

Window frames 124 and 125 may be static or move along window guiding elements 173 and 174. The movement may be horizontal or vertical.

FIG. 9 illustrates wall 10 having interior 12 and exterior 11 surfaces.

The window frame has an exterior portion 181 and an inner portion 182.

The exterior portion 181 of the window frame extends outside the wall opening 14 and includes a rollable shutter guiding element 171.

The inner portion 182 of the window frame is positioned within the wall opening 14.

The window frame includes or is coupled to an internal portion 191 (FIG. 8 illustrates an adjustable internal portion 191 that has a L-shaped cross section). FIG. 8 illustrates the two extremum positions of the internal portion—that enable to connect the window frame to walls of different thickness.

The inner portion 182 includes screen guiding element 172, window guiding element 173, electrical switch 201, and window hinge 202. Window frame 124 is pivotally coupled to the window frame via the window hinge 202.

FIG. 9 also illustrates screen 104 and screen frame 121.

Screen frame 121 may be static or may be configured to move along screen guiding element 172.

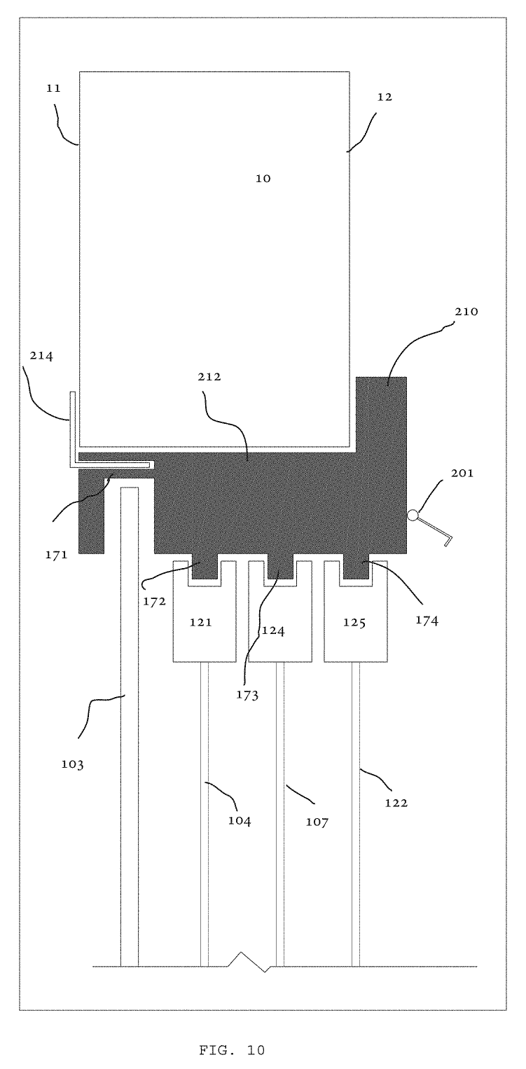

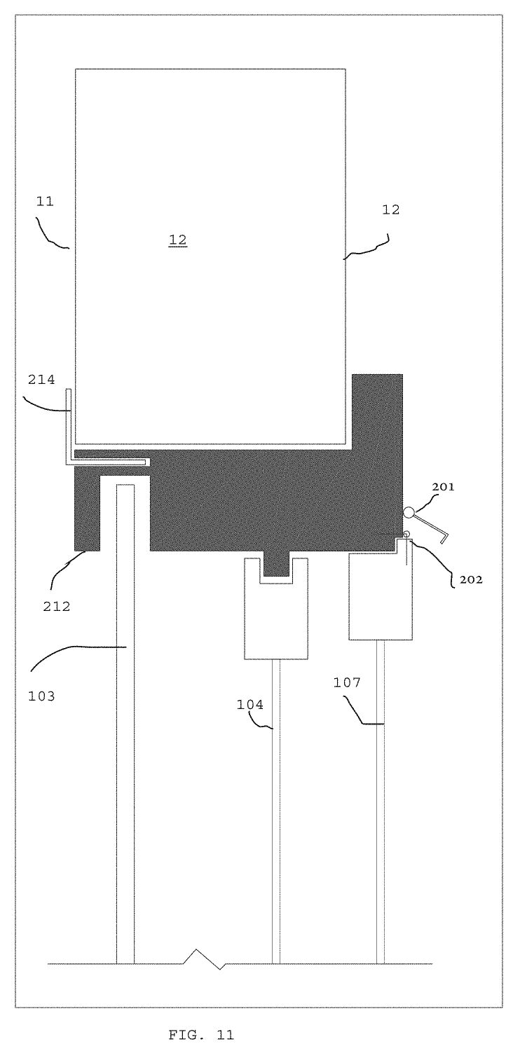

FIG. 10 illustrates wall 10 having interior 12 and exterior 11 surfaces.

The window frame includes a front portion 212 and an internal interface 210.

The front portion 212 of the window frame is positioned within wall opening 14 and includes a rollable shutter guiding element 171, screen guiding element 172, window guiding element 173 and electrical switch 201.

The internal interface 210 of the window frame is positioned outside the wall opening 14—extends towards the interior of a room that is delimited by wall 10. An exterior portion 214 (may be adjustable or not) is used to connect the window frame to the exterior surface of the wall.

FIG. 10 also illustrates screen 104, screen frame 121, windows 107 and 122 and window frames 124 and 125.

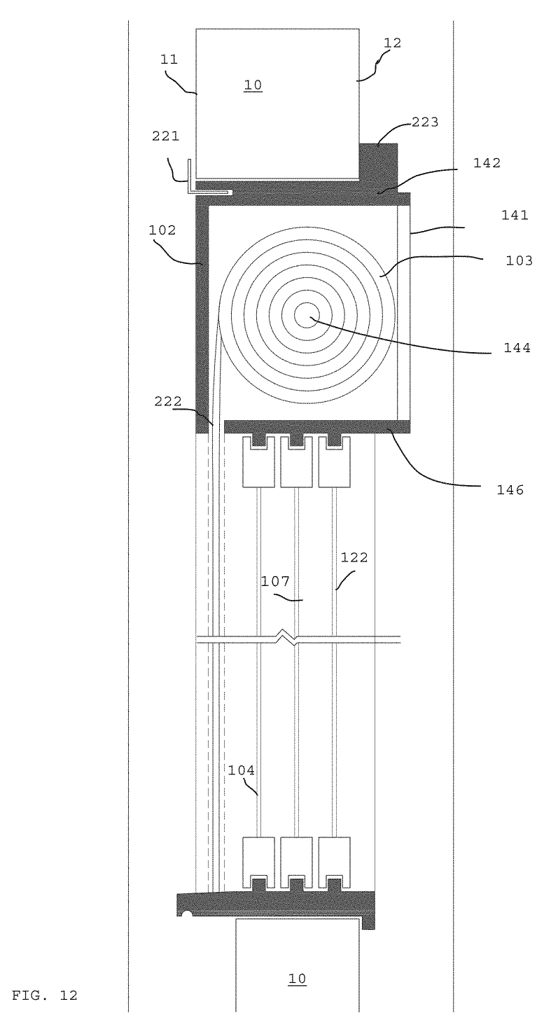

FIG. 11 illustrates wall 10 having interior 12 and exterior 11 surfaces.

The window frame includes a front portion 212 and an internal interface 210.

The front portion 212 of the window frame is positioned within wall opening 14 and includes a rollable shutter guiding element 171, screen guiding element 172, electrical switch 201, and window hinge 202. Window frame 124 is pivotally coupled to the window frame via the window hinge 202.

The internal interface 210 of the window frame is positioned outside the wall opening 14—extends towards the interior of a room that is delimited by wall 10. An exterior portion 214 (may be adjustable or not) is used to connect the window frame to the exterior surface of the wall.

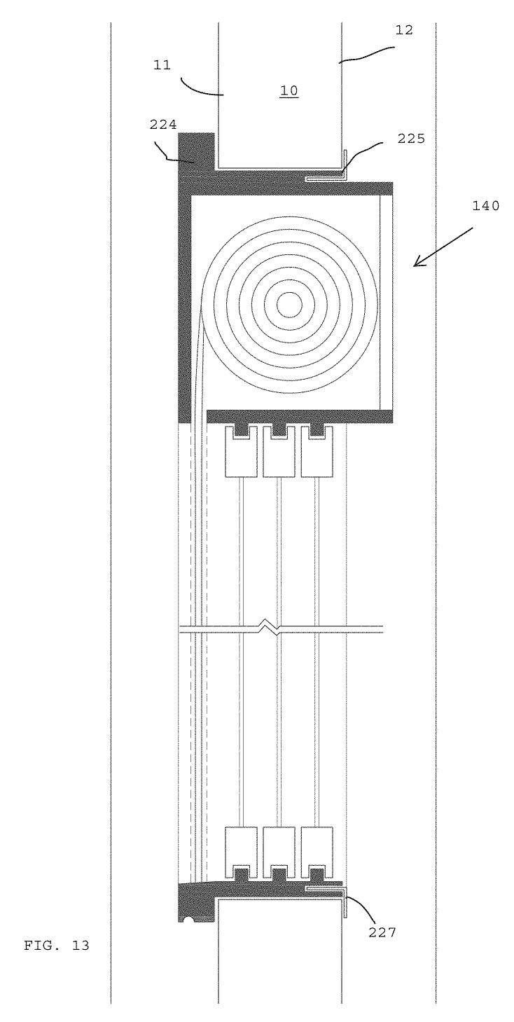

Each one of FIG. 12-13 is an example of a cross sectional view that is taken along a vertical plane that crosses the bottom and top rims of the window frame.

FIG. 12 illustrates wall 10 having interior 12 and exterior 11 surfaces.

The window frame of FIG. 12 is substantially the same as the window frame of FIG. 10—it includes a front portion and an interior portion.

FIG. 12 illustrates the upper rim 146 of the window frame as serving also as the bottom panel 146 of the housing of the motorized rollable shutter system.

An interior interface 223 extends above the upper rim 146 and is used to contact the interior surface of wall.

An exterior interface 221 is coupled to the housing and is used for connecting the integrated system to the wall.

FIG. 12 also illustrated an opening formed in the upper rim 146 for allowing the rollable shutter to exit the housing or to enter the housing during folding and unfolding operations.

FIG. 12 also illustrates rollable shutter 103 that is rolled over rollable element 144, panels 102 and 141 of the housing, screen 104, frame 107, and window 122.

FIG. 13 illustrates wall 10 having interior 12 and exterior 11 surfaces.

The window frame of FIG. 13 is substantially the same as the window frame of FIG. 8—it includes an exterior portion and an inner portion.

FIG. 13 illustrates the upper rim 146 of the window frame as serving also as the bottom panel 146 of the housing of the motorized rollable shutter system.

An exterior interface 224 extends above the upper rim 146 and is used to contact the exterior surface of wall.

An interior interface 225 is coupled to the housing and is used for connecting the integrated system to the wall.

FIGS. 1-13 illustrates various examples of an integrated system. It is noted the these are non-limiting examples. For example—the window frame may have any shape (a rectangular or non-rectangular shape), the guiding elements may be rails, tunnels, slots, or any type of perturbances or cavities, the integrated system may include any number of screens and screen guiding elements- and even may not include any screen or screen guiding element, the integrated system may include additional shading elements, the integrated system may include any number of windows and window guiding elements—and even may not include any window, there may be any spatial relationship between the different guiding elements, the integrated system may extend outwards and inwards of the window opening.

For simplicity of explanation the motor of the motorized rollable shutter system is not shown. Those of ordinary skill in the art will appreciate that the any motor may be used—especially a motor that is located within the housing of the motorized rollable shutter system.

The rolling element may be a cylinder—but is have any other shape.

There may be provided a method 300 for installing an integrated system.

The method may include of installing the integrated system within a wall opening of a wall. The integrated system may include a motorized rollable shutter system and a window frame; wherein the motorized rollable shutter system comprises a housing, a rollable shutter, a rolling element, and motor for rotating the rolling element, wherein a rotation of the rolling element assists to in a winding and an unwinding of the rollable shutter; wherein window frame the is either connected to the housing or is integrated with the housing; wherein the window frame comprises at least one rollable shutter guiding element for guiding the a rollable shutter during a rolling and unrolling of the rollable shutter; and wherein the window frame comprises at least one window guiding element for guiding at least one window when the at least one window moves in relation to the window frame.

The installing may include positioning at least a part of the integrated system in the wall opening, optionally adjusting one or more adjustable interfaces to the exterior and/or interior surfaces of the wall, and connecting the window frame to the wall.

The connecting may include using any connecting elements such as bolts, screws, and the like.

The connecting may also include placing glue or/and adhesive material on the wall opening and/or on the interior and/or exterior of the wall before positioning the integrated system in the wall opening.

It should be noted that the integrated system may interface only a wall (for example—as illustrated by the mentioned above figures)—but may interface with the wall and the floor. Alternatively—the integrated system may interface the wall and the ceiling. Yet for another example—the integrated system may interface the floor on one hand and the ceiling on one hand and may surround a floor to ceiling window.

| # | Component/unit |
|---|---|
| 10 | Wall |
| 11 | Exterior surface of the wall |
| 12 | Interior surface of the wall |
| 14 | Wall opening |
| 100 | Integrated system |
| 102 | Exterior panel of housing (of motorized rollable shutter system) |
| 103 | Rollable shutter |
| 104 | Screen |
| 106 | Bottom rim of window frame |
| 107 | Window |
| 108 | Side rim of window frame |
| 109 | Screen guiding element |
| 110 | Window guiding element |
| 111 | Window guiding element |
| 112 | Interior interface of window frame |
| 113 | Interior panel of housing (of motorized rollable shutter system) |
| 121 | Screen frame |
| 122 | Window |
| 123 | Bottom rim of window frame |
| 124 | Window frame |
| 125 | Window frame |
| 126 | Cavity (in window frame) for insertion of an internal interface |
| 131 | Interior interface |
| 140 | Motorized rollable shutter system |
| 141 | Interior panel of housing |
| 142 | Upper part of the housing |
| 144 | Rollable element |
| 145 | Another rollable element |
| 146 | Bottom panel of the housing |
| 148 | Side panel of the housing |
| 149 | Side panel of the housing |
| 161 | Side rim of window frame |
| 171 | Guiding element of the rollable shutter (side portion) |
| 172 | Screen guiding element |
| 173 | Window guiding element |
| 174 | Window guiding element |
| 181 | Exterior part of window frame |
| 182 | Inner portion of window frame |
| 191 | Internal interface |
| 201 | Electrical switch (for activation of the motor of the motorized |
| | rollable shutter system). It is electrically coupled to the motor. |
| 202 | Window hinge |
| 210 | Interior portion of window frame |
| 212 | Front portion of window frame |
| 214 | Exterior portion |

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. An integrated system, comprising: a motorized rollable shutter system and a window frame;
wherein the motorized rollable shutter system comprises a housing, a rollable shutter, a rolling element, and a motor for rotating the rolling element, wherein a rotation of the rolling element assists to in a winding of the rollable shutter and an unwinding of the rollable shutter;
wherein window frame is either connected to the housing or is integrated with the housing;
wherein the window frame comprises at least one rollable shutter guiding element for guiding the rollable shutter during a rolling and unrolling of the rollable shutter; and
wherein the window frame comprises at least one window guiding element for guiding at least one window when the at least one window moves in relation to the window frame.

2. The integrated system according to claim 1 wherein the at least one rollable shutter guiding element is parallel to one more of the at least one window guiding element.

3. The integrated system according to claim 1 wherein the at least one rollable shutter guiding element comprises at least one recess formed in the window frame and wherein the at least one window guiding element comprises at least one rail.

4. The integrated system according to claim 1 wherein the at least one rollable shutter guiding element is formed in an exterior portion of the window frame, wherein the at least one window guiding element belongs to an inner portion of the window frame.

5. The integrated system according to claim 4, wherein the inner portion of the window frame is shaped and sized to fit in a portion of a wall opening that is formed within a wall; and wherein the exterior portion of the window frame is shaped and sized to extend outside the wall opening.

6. The integrated system according to claim 5, wherein the window frame further comprises an adjustable internal interface that is configured to interface with an interior surface of the wall.

7. The integrated system according to claim 5, wherein the window frame further comprises a non-adjustable internal interface that is configured to interface within an interior surface of the wall.

8. The integrated system according to claim 4, wherein the at least one rollable shutter guiding element comprises a pair of recesses that are positioned at opposite sides of the window frame; wherein the at least one window guiding element comprises a pair of rails that are positioned at the opposite sides of the window frame; wherein a distance between the pair of recesses differs from a distance between the pair of rails.

9. The integrated system according to claim 1 wherein the at least one rollable shutter guiding element is formed in a front portion of the window frame, wherein the at least one window guiding element belongs to an interior portion of the window frame; wherein the front portion of the window frame is shaped and sized to fit in a portion of a wall opening of a wall; and wherein the interior portion of the window frame is shaped and sized to extend outside the wall opening and to interface with an interior surface of the wall.

10. The integrated system according to claim 9, wherein the window frame further comprises an adjustable internal interface that is configured to interface within an exterior portion of the wall.

11. The integrated system according to claim 9, wherein the at least one rollable shutter guiding element comprises a pair of recesses that are positioned at opposite sides of the window frame; wherein the at least one window guiding element comprises a pair of rails that are positioned at the opposite sides of the window frame; wherein a distance between the pair of recesses differs from a distance between the pair of rails.

12. The integrated system according to claim 1 comprising the at least one window.

13. The integrated system according to claim 1 wherein the rolling element is adapted to have the rollable shutter wrapped around.

14. The integrated system according to claim 1, comprising an additional rolling element that is spaced apart from the rolling element, and wherein the rollable shutter is configured to be wrapped around the rolling element and the additional rolling element.

15. The integrated system according to claim 1, wherein the motorized rollable shutter system is positioned above the window frame.

16. The integrated system according to claim 1, comprising at least one screen interface that is connected to a screen.

17. The integrated system according to claim 1, comprising at least movable screen that is configured to move along at least one screen interface of the integrated system.

18. The integrated circuit according to claim 1 wherein the at least one window guiding element is configured to guide the at least one window when the at least one window performs a rotational movement in relation to the window frame.

19. The integrated circuit according to claim 1 wherein the at least one window guiding element is configured to guide the at least one window when the at least one window performs a vertical movement in relation to the window frame.

20. The integrated circuit according to claim 1 wherein the at least one window guiding element is configured to guide the at least one window when the at least one window performs a horizontal movement in relation to the window frame.

21. A method for installing an integrated system, the system comprises installing the integrated system within a wall opening of a wall; wherein the integrated system comprises a motorized rollable shutter system and a window frame; wherein the motorized rollable shutter system comprises a housing, a rollable shutter, a rolling element, and motor for rotating the rolling element, wherein a rotation of the rolling element assists to in a winding and an unwinding of the rollable shutter; wherein window frame the is either connected to the housing or is integrated with the housing; wherein the window frame comprises at least one rollable shutter guiding element for guiding the a rollable shutter during a rolling and unrolling of the rollable shutter; and wherein the window frame comprises at least one window guiding element for guiding at least one window when the at least one window moves in relation to the window frame.
